(19) United States
(12) Patent Application Publication
(10) Pub. No.: US 2024/0400003 A1
(43) Pub. Date: Dec. 5, 2024

(54) SENSOR ASSEMBLY HAVING TELESCOPING NOZZLE

(71) Applicant: Ford Global Technologies, LLC, Dearborn, MI (US)

(72) Inventors: Venkatesh Krishnan, Canton, MI (US); Segundo Baldovino, Novi, MI (US); Michael Robertson, Jr., Garden City, MI (US)

(73) Assignee: Ford Global Technologies, LLC, Dearborn, MI (US)

(21) Appl. No.: 18/325,318

(22) Filed: May 30, 2023

(51) Int. Cl. B60S 1/52; B60S 1/48; B60S 1/50; H04N 23/52; H04N 23/54

(52) U.S. Cl. CPC B60S 1/52; B60S 1/481; B60S 1/50; H04N 23/52; H04N 23/54

(57) ABSTRACT

A sensor assembly includes a sensor mounted to a movable panel of a vehicle and a telescoping nozzle mounted to a fixed panel of the vehicle. The movable panel can be movable relative to the fixed panel between an open position and a closed position. The telescoping nozzle can be extendable between a retracted position behind the fixed panel and an extended position extending from the fixed panel. The telescoping nozzle can be aimed at a surface of the sensor responsive to the movable panel being in the closed position and the telescoping nozzle being in the extended position.

### BACKGROUND

Autonomous and semi-autonomous vehicles typically include a variety of sensors. Some sensors detect the position or orientation of the vehicle, such as, for example, satellite positioning system sensors (e.g., GPS sensors); accelerometers (e.g., piezo-electric or microelectromechanical systems); gyroscopes (e.g., rate sensors, ring laser gyroscopes, fiber-optic gyroscopes, inertial measurement units, magnetometers, etc.). Other sensors detect objects external to a vehicle, for example, radar sensors, scanning laser range finders, light detection and ranging (lidar) devices, and imaging sensors such as cameras. Surfaces of sensors to detect objects external to a vehicle may undergo a cleaning process, which precludes sensor surfaces from accumulating dust, dirt, or other obscurants.

### BRIEF DESCRIPTION OF THE DRAWINGS

FIG. 1 is a block diagram of an example vehicle system.

FIG. 2 is a perspective view of a telescoping nozzle and a sensor mounted to a downward-facing portion of a vehicle side mirror structure.

FIG. 3 is a flowchart of an example process for operating a sensor assembly.

### DETAILED DESCRIPTION

A sensor assembly can include a sensor mounted to a movable panel of a vehicle and a telescoping nozzle mounted to a fixed panel of the vehicle. The movable panel can be movable relative to the fixed panel between an open position and a closed position. The telescoping nozzle can be extendable between a retracted position behind the fixed panel and an extended position extending from the fixed panel. The telescoping nozzle can be aimed at a surface of the sensor responsive to the movable panel being in the closed position and the telescoping nozzle being in the extended position.

The movable panel can be an exterior panel of a door of the vehicle.

The fixed vehicle of the panel can be a fender of the vehicle.

The sensor can be fixed to a side mirror structure that is mounted to the movable panel.

The side mirror structure can extend outward from the movable panel.

The telescoping nozzle can be fluidly coupled via a fluid conduit to a pump, and the fluid conduit can be routed exclusively through a portion of the vehicle that excludes the side mirror structure.

The sensor can be fixed to a downward-facing portion of the side mirror structure.

The sensor can include a camera.

The camera can include a field-of-view that includes an area in a forward direction with respect to the vehicle.

The field-of-view can include an area in a rearward direction with respect to the vehicle and an area to a side of the vehicle.

The telescoping nozzle can be fluidly coupled to a pump, and the telescoping nozzle can be arranged to move to the extended position responsive to an increase in fluid pressure generated by the pump.

The telescoping nozzle can be fluidly coupled to a pump, and the telescoping nozzle can be arranged to move to the retracted position responsive to a decrease in fluid pressure generated by the pump.

The telescoping nozzle can be fluidly coupled via a fluid conduit to a pump, and the fluid conduit can be routed exclusively through a portion of the vehicle that excludes the movable panel.

The telescoping nozzle can be fluidly coupled via a fluid conduit to a pump coupled to a windshield washer fluid reservoir.

The telescoping nozzle can include a trim panel cover of the vehicle at a distal end of the telescoping nozzle.

The trim panel can have a shape that matches a shape of an opening in a fender of the vehicle.

The trim panel cover can be flush with the fender in the opening responsive to the telescoping nozzle being retracted.

The assembly can include a controller programmed to detect an obscurant on the surface of the sensor.

The controller can be further programmed to actuate a pump that is fluidly coupled to the telescoping nozzle responsive to detection of the obscurant.

The controller can further be programmed to actuate a pump fluidly coupled to the telescoping nozzle responsive to detection of the obscurant and the vehicle being operated in an assisted driving mode.

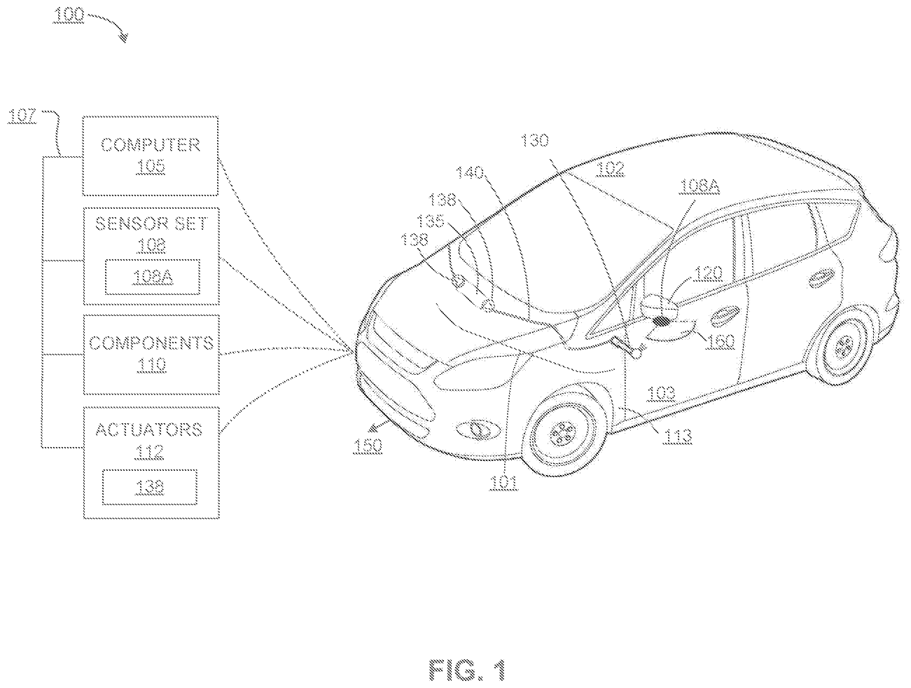

With reference to the Figures, wherein like numerals indicate like parts throughout the several views, FIG. 1 is a block diagram of an example vehicle system 100. Vehicle system 100 can include vehicle 102. Vehicle 102 can include a land vehicle, such as a car, truck, a sport utility vehicle, a crossover, a van, a minivan, a taxi, a bus, etc. Vehicle system 100 includes computer 105, which may utilize vehicle communications bus 107 to communicate with sensor set 108. Sensor set 108 of vehicle system 100 can include any sensors for detecting the attributes of an environment external to vehicle 102, such as objects and/or characteristics of surroundings of vehicle 102. Accordingly, sensor set 108 may include sensor 108A, which may correspond to a camera to capture images of moving or static objects in the driving environment of vehicle 102.

Sensor assembly 101 includes movable panel 103, fixed panel 113, sensor 108A, side mirror structure 120, telescoping nozzle 130, washer fluid reservoir 135, and washer fluid pumps 138. As seen in FIG. 1, sensor 108A can be mounted on movable panel 103, which may correspond to an exterior door panel of vehicle 102. Sensor 108A can be physically integrated with side mirror structure 120, which may extend in an outward direction from fixed panel 113. Sensor 108A may be aimed generally downward, e.g., with a center of field-of-view 160 directed downward and with field-of-view 160 encompassing an area forward, rearward, and to one side of vehicle 102. Accordingly, sensor 108A may be capable of providing digitized images of moving or static objects located within field-of-view 160. Thus, sensor 108A can provide digitized images of moving vehicles, road markings, traffic lights, traffic signs, pedestrians, natural objects, etc. located in a forward direction with respect to vehicle 102, in a rearward direction with respect to vehicle 102, and to the side of vehicle 102 to which sensor 108A is mounted.

Signals representing digitized images captured by sensor 108A may be transmitted to vehicle computer 105, which may execute image processing programming to extract features of the environment external to vehicle 102. Vehicle computer 105 may execute programming to fuse output signals from other sensors of sensor set 108, which can be mounted at a top portion of vehicle 102, at a rear portion of vehicle 102, at a front windshield, around vehicle 102, etc. Such sensors may provide relative locations, sizes, and shapes of objects and/or conditions surrounding vehicle 102. Although not explicitly shown in FIG. 1, a second sensor 108A, located on an opposite side of vehicle 102, can provide digitized images of moving or static objects in a forward direction with respect to vehicle 102, to the rear of vehicle 102, and to the opposite (e.g., right hand) side of vehicle 102. Accordingly, programming of vehicle computer 105 can receive and process digitized images in all directions in a horizontal plane as vehicle 102 proceeds along path 150.

Vehicle computer 105 may additionally include programming to operate one or more of vehicle 102 brakes, propulsion (e.g., control of acceleration in the vehicle by controlling one or more of an internal combustion engine, electric motor, hybrid engine, etc.), steering, climate control, interior and/or exterior lights, etc. Vehicle computer 105 may include or be communicatively coupled to more than one processor, e.g., included in electronic controller units (ECUs) or the like included in vehicle 102 for monitoring, actuating, and/or controlling various vehicle actuators 112, e.g., a powertrain actuator, a brake actuator, a steering actuator, fluid pumps (e.g., washer fluid pump 138), etc. Actuators 112 can be implemented via circuits, chips, indicators (e.g., lamps, audible indicators, haptic indicators), motors (e.g., stepper motors), or other electronic and/or mechanical components that can actuate various vehicle subsystems in accordance with appropriate control signals. Vehicle computer 105 may communicate with the various sensors of sensor set 108, components 110, and actuators 112 utilizing vehicle communications bus 107, which can include an internal wired and/or wireless network, such as a controller area network (CAN) or the like, and/or other wired and/or wireless mechanisms. Vehicle computer 105 includes a processor and a memory, which can include one or more forms of computer-readable media, and stores instructions executable by vehicle computer 105 for performing various operations, including those disclosed herein.

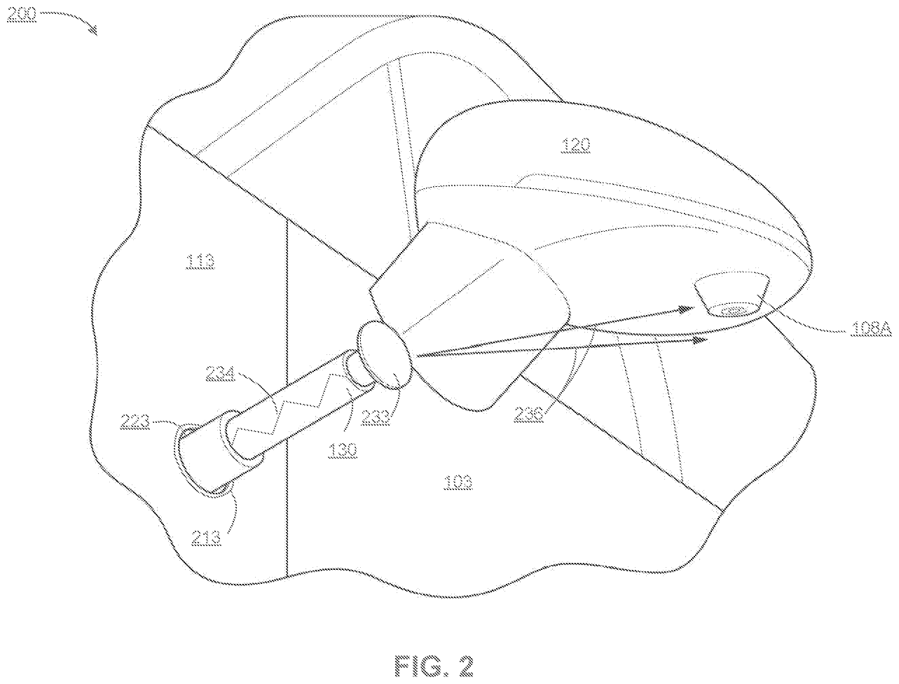

In an example, responsive to vehicle system 100 being operated in an autonomous or semi-autonomous driving mode, programming of vehicle computer 105 may utilize various output signals from sensors of sensor set 108 to perform control operations without inputs from the operator of vehicle system 100. To prevent sensors of sensor set 108 from accumulating obscurants, such as dirt, dust, mud, insects, etc., vehicle computer 105 may initiate operations to clean surfaces of sensors of sensor set 108. Thus, for example, to prevent a surface of sensor 108A from accumulating obscurants, vehicle computer 105 may actuate washer fluid pump 138 coupled to washer fluid reservoir 135 to clean the surface of sensor 108A. Responsive to fluid pressure generated by washer fluid pump 138, washer fluid can be transported through fluid conduit 140, routed beneath fixed panel 113 for coupling to an input side of telescoping nozzle 130. In turn, telescoping nozzle 130 may be extended from a location within an opening (e.g., opening 223 of FIG. 2) in fixed panel 113. Upon extension of telescoping nozzle 130, a distal portion of the telescoping nozzle, aimed or directed toward a surface of sensor 108A, may dispense washer fluid. After a brief dispensing of washer fluid to the surface of sensor 108A, vehicle computer 105 may deactivate washer fluid pump 138, thereby decreasing fluid pressure generated by washer fluid pump 138. Responsive to decreasing fluid pressure, telescoping nozzle 130 may be retracted, such as by way of spring 234 within the body of telescoping nozzle 130, thus returning to a location within opening 223 of fixed panel 113. Accordingly, sensor 108A may remain free of obscurants, thus providing vehicle computer 105 with precise digitized representations of moving and static objects within field-of-view 160 of sensor 108A.

In an example, vehicle computer 105 may be programmed to initiate operations to clean a surface of sensor 108A in response to detection of a degradation in performance of the sensor. For example, in response to image processing programming of vehicle computer 105 detecting a pixel area within field-of-view 160 that does not appear to change between successive image frames, vehicle computer 105 may determine that dirt, mud, or another obscurant is present on a surface of sensor 108A. Accordingly, vehicle computer 105 may actuate washer fluid pump 138 to transport fluid from washer fluid reservoir 135. Responsive to actuation of washer fluid pump 138, via conduit 140, telescoping nozzle 130 can be extended to aim a distal portion of the telescoping nozzle at the surface of sensor 108A and to dispense washer fluid to the sensor surface. In an example, vehicle computer 105 may initiate a process to clean a surface of sensor 108A when vehicle system 100 is operated in an assisted (e.g., semi-autonomous or autonomous) driving mode.

FIG. 2 is a perspective view of an assembly 200 that includes telescoping nozzle 130 and sensor 108A. Sensor 108A can be fixed to a downward-facing portion of side mirror structure 120 of vehicle 102. Sensor 108A of FIG. 2 can be a camera capable of digitizing images representing moving or static objects from areas to the front, rear, and to a side of vehicle 102. Sensor 108A can be mounted to movable panel 103, which may correspond to an outer door panel of vehicle 102. As previously mentioned herein, a surface of sensor 108A may be intermittently cleaned, such as utilizing fluid from washer fluid reservoir 135 of vehicle 102, to prevent accumulation of obscurants that could potentially degrade performance of the sensor.

In FIG. 2, movable panel 103 is placed in a closed position. In a retracted position, telescoping nozzle 130 is held within (e.g., behind) fixed panel 113 via tension from spring 234. Accordingly, in an initial position, trim panel cover 233 is situated within and surrounded by trim panel 213 of fixed panel 113. While telescoping nozzle 130 is held in a retracted position within fixed panel 113, tension from spring 234 is greater than any fluid pressure with washer fluid pump 138 not activated. Accordingly, trim panel cover 233 remains flush with trim panel 213 and fixed panel 113. In the context of this disclosure, “flush” is defined as having a difference in height of less than two millimeters.

In an example, to prevent accumulation of obscurants on a surface of sensor 108A, computer 105 may actuate washer fluid pump 138, which generates fluid pressure within fluid conduit 140. In response to fluid pressure at an input port of telescoping nozzle 130 overcoming tension from spring 234, telescoping nozzle 130 may be extended from opening 223 of fixed panel 113. In an example, as the body of telescoping nozzle 130 is filled with pressurized fluid, one or more bushings, such as at the base of telescoping nozzle 130, may prevent or at least reduce fluid leakage during extension of the nozzle. The body of telescoping nozzle 130 may thus continue to fill with pressurized fluid and continue to extend outwardly from fixed panel 113 until the telescoping nozzle reaches a mechanical stop or until an expansion force responsive to fluid pressure from fluid conduit 140 approaches a tensile force generated by spring 234.

At an extended position and in response to a continued presence of fluid pressure within telescoping nozzle 130, fluid from washer fluid reservoir 135 may be dispensed to the surface of sensor 108A as indicated by arrows 236. Fluid can continue to be dispensed so long as washer fluid pump is actuated. In response to deactivation of washer fluid pump 138, fluid pressure within fluid conduit 140 may begin to decrease. As the fluid pressure decreases, a tensile force from spring 234 or any other resilient element within the body of telescoping nozzle 130, may bring about retraction of the telescoping nozzle through opening 223 and to a position behind fixed panel 113. Retraction of telescoping nozzle 130 may be halted responsive to trim panel cover 233 being brought into contact with trim panel 213. In example, trim panel cover 233 can include an inner lip or ring that is recessed from the outer portion of the trim panel. In response to contacting the inner lip or ring, trim panel cover 233 can be flush with the outer portion of trim panel 213. Alternatively, or in addition, the length of telescoping nozzle 130 may be sized so as to retract to a position that is fully within fixed panel 113 thereby exposing (exclusively) trim panel cover 233. Telescoping nozzle 130, trim panel 213, and trim panel cover 233 may be formed from any suitable materials, such as a synthetic polymer, acrylonitrile butadiene styrene plastic, polycarbonate, an acetal copolymer, an acetal homopolymer, etc.

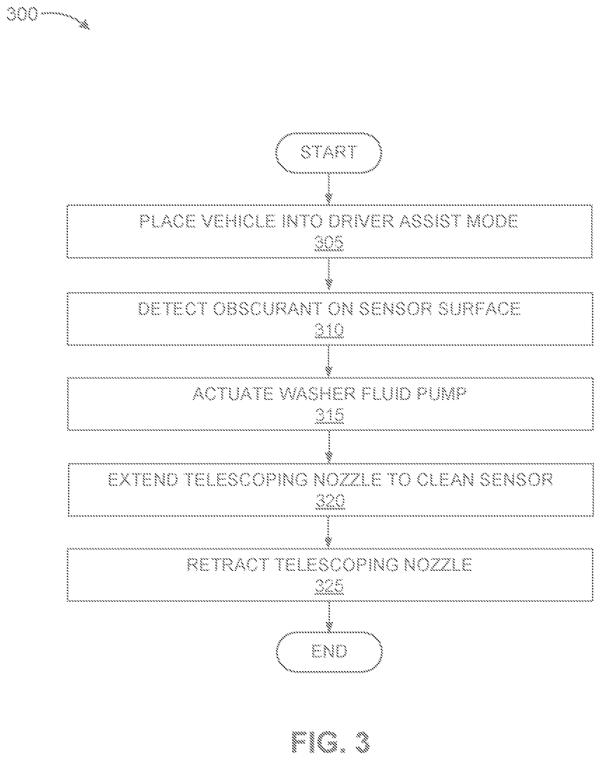

FIG. 3 is a flowchart of an example process 300 for operating a sensor assembly.

Process 300 can be performed via programming of vehicle computer 105, which may operate, for example, to prevent accumulation of obscurants on a surface of sensor 108A. Alternatively, or in addition, responsive to vehicle computer 105 detecting an obscurant on a surface of sensor 108A, vehicle computer 105 may initiate an operation to clean the surface of sensor 108A. Alternatively, or in addition, an operator of vehicle system 100 may manually initiate a cleaning operation upon determining that an obscurant is present on a surface of sensor 108A. Process 300 begins at block 305, in which programming of vehicle computer 105 determines that vehicle system 100 has been placed into a driver assistance mode, which may include autonomous or semi-autonomous operation. Block 305 may include an operator selecting to place vehicle system 100 into an autonomous or semi-autonomous mode by interfacing with a human-machine interface of vehicle system 100, such as while operating the vehicle system in traffic, e.g., with movable panel 103 in a closed position.

Process 300 may continue at block 310, in which an obscurant is detected on a surface of sensor 108A. In an example, vehicle computer 105 may detect an obscurant via determining that a pixel area within field-of-view 160 of sensor 108A does not appear to change between successive image frames. Alternatively, or in addition, an operator of vehicle system 100 may determine, such as by way of viewing a display that presents an image of an area external to vehicle 102, that appears to indicate dust, dirt, or another obscurant viewable in a displayed image.

Process 300 may continue at block 315, in which vehicle computer 105 may actuate washer fluid pump 138. Actuation of washer fluid pump 138 may bring about an increase in pressure of a fluid transported via fluid conduit 140 to an input port of telescoping nozzle 130.

Process 300 may continue at block 320, in which, responsive to the increase in fluid pressure at the input port of telescoping nozzle 130, the telescoping nozzle may emerge from opening 223 of fixed panel 113. Telescoping nozzle 130 may extend towards a surface of sensor 108A and be aimed at the sensor surface. Telescoping nozzle 130 may then dispense washer fluid, which operates to clean the surface of sensor 108A.

Process 300 may continue at block 325, in which vehicle computer 105 may deactivate washer fluid pump 138, which may bring about a decrease in pressure at the input port of telescoping nozzle 130, the telescoping nozzle may retract toward opening 223 of fixed panel 113. In response to retraction of telescoping nozzle 130, trim panel cover 233 may contact trim panel 213, which stops further retraction of telescoping nozzle 130 into opening 223. After retraction of telescoping nozzle 130, trim panel cover 233 may be flush with trim panel 213 and fixed panel 113.

After block 325, process 300 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script. Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It should further be understood that certain steps could be performed simultaneously, that other steps could be added, or that certain steps described herein could be omitted.

All terms used in the claims are intended to be given their plain and ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary. The adjectives “first.” “second.” and “third” are used throughout this document as identifiers and are not intended to signify importance, order, or quantity. Use of “in response to” and “upon determining” indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A sensor assembly, comprising:
a sensor mounted to a movable panel of a vehicle; and
a telescoping nozzle mounted to a fixed panel of the vehicle;
the movable panel being movable relative to the fixed panel between an open position and a closed position;
the telescoping nozzle being extendable between a retracted position behind the fixed panel and an extended position extending from the fixed panel; and
the telescoping nozzle being aimed at a surface of the sensor responsive to the movable panel being in the closed position and the telescoping nozzle being in the extended position.

2. The sensor assembly of claim 1, wherein the movable panel is an exterior panel of a door of the vehicle.

3. The sensor assembly of claim 1, wherein the fixed panel of the vehicle is a fender of the vehicle.

4. The sensor assembly of claim 1, wherein the sensor is fixed to a side mirror structure that is mounted to the movable panel.

5. The sensor assembly of claim 4, wherein the side mirror structure extends outward from the movable panel.

6. The sensor assembly of claim 4, wherein the telescoping nozzle is fluidly coupled via a fluid conduit to a pump, and wherein the fluid conduit is routed exclusively through a portion of the vehicle that excludes the side mirror structure.

7. The sensor assembly of claim 4, wherein the sensor is fixed to a downward-facing portion of the side mirror structure.

8. The sensor assembly of claim 1, wherein the sensor includes a camera.

9. The sensor assembly of claim 8, wherein the camera has a field-of-view that includes an area in a forward direction with respect to the vehicle.

10. The sensor assembly of claim 9, wherein the field-of-view includes an area in a rearward direction with respect to the vehicle and an area to a side of the vehicle.

11. The sensor assembly of claim 1, wherein the telescoping nozzle is fluidly coupled to a pump, and wherein the telescoping nozzle is arranged to move to the extended position responsive to an increase in fluid pressure generated by the pump.

12. The sensor assembly of claim 1, wherein the telescoping nozzle is fluidly coupled to a pump, and wherein the telescoping nozzle is arranged to move to the retracted position responsive to a decrease in fluid pressure generated by the pump.

13. The sensor assembly of claim 1, wherein the telescoping nozzle is fluidly coupled via a fluid conduit to a pump, and wherein the fluid conduit is routed exclusively through a portion of the vehicle that excludes the movable panel.

14. The sensor assembly of claim 1, wherein the telescoping nozzle is fluidly coupled via a fluid conduit to a pump coupled to a windshield washer fluid reservoir.

15. The sensor assembly of claim 1, wherein the telescoping nozzle includes a trim panel cover at a distal end of the telescoping nozzle.

16. The sensor assembly of claim 15, wherein the trim panel has a shape matching a shape of an opening in a fender of the vehicle.

17. The sensor assembly of claim 16, wherein the trim panel cover is flush with the fender in the opening responsive to the telescoping nozzle being retracted.

18. The sensor assembly of claim 1, further comprising a controller programmed to detect an obscurant on the surface of the sensor.

19. The sensor assembly of claim 18, wherein the controller is further programmed to actuate a pump that is fluidly coupled to the telescoping nozzle responsive to detection of the obscurant.

20. The sensor assembly of claim 18, wherein the controller is further programmed to actuate a pump fluidly coupled to the telescoping nozzle responsive to detection of the obscurant and the vehicle being operated in an assisted driving mode.
